(19) United States
(12) Patent Application Publication
(10) Pub. No.: US 2025/0180047 A1
(43) Pub. Date: Jun. 5, 2025

(54) JOINING SYSTEM

(71) Applicant: Airbus Operations S.L.U., GETAFE (ES)

(72) Inventors: David MARTÍN CALVO, GETAFE (ES); Esther SOLA CASADO, GETAFE (ES); Joaquín Andrés JIMÉNEZ NUÑEZ, GETAFE (ES); Raúl GÓMEZ VIZCAÍNO, GETAFE (ES); Nuria COLMENAREJO MATELLANO, GETAFE (ES)

(21) Appl. No.: 18/967,190

(22) Filed: Dec. 3, 2024

(30) Foreign Application Priority Data
Dec. 4, 2023 (ES) 202331009

(51) Int. Cl. F16B 5/02

(52) U.S. Cl. CPC F16B 5/02

(57) ABSTRACT

A joining system, between a first anterior element and a second posterior element, comprising a through hole. The joining system has a threaded bolt for passing through the through hole of the first element and the second element, a shank configured to be located concentrically to the threaded bolt in at least the anterior longitudinal zone of the threaded bolt and to move together with the threaded bolt, the shank comprising an outer face comprising at least one tapered longitudinal section, a housing attached to the second posterior element and comprising a conical inner face for housing the shank, and a clamping element configured for the threading of the posterior longitudinal zone of the threaded bolt for fastening the joining system.

### CROSS-REFERENCES TO RELATED APPLICATIONS

This application claims the benefit of Spanish Patent Application Number 202331009 filed on Dec. 4, 2023, the entire disclosure of which is incorporated herein by way of reference.

### FIELD OF THE INVENTION

The invention is related to the technical field of joining systems between structural elements. More specifically, it is related to joints between panels in the aeronautical sector.

### BACKGROUND OF THE INVENTION

There are many known systems for connecting two structures with a hole to insert an element of a joining system.

For example, bolted structural connections are well known. These joints have the disadvantage of requiring the elements to be joined to be located in a precisely aligned position, as this type of joint does not allow for misalignment to be absorbed. Likewise, these joints do not allow control of the load transmitted during the assembly and disassembly of the joint system. In addition, their disassembly is sometimes complicated since it is necessary to access both sides of the joint system, which is not always possible or easy.

Slack-fit type joints are also known. These joints still have the disadvantage that they don't have the capacity to absorb misalignment between the elements to be joined, and it is not possible to control the load transmitted by the joint system during assembly and disassembly. Additionally, this joint system can provide a loose fit of the bolt and has low load transfer due to the slack fit itself.

Quick fasteners are also known. This type of joint does allow for a small amount of misalignment absorption between the elements to be joined. However, this type of joint also has the disadvantage of providing a loose bolt fit and having low load transfer. They also have the disadvantage of requiring perpendicular installation since installation occurs in the direction of the threaded portion, which is perpendicular to the joint, and they have no tilting capability.

Conical shank fasteners are also known. This type of fastening can absorb small misalignments, although it requires the holes of the elements to be joined to be conical.

Also well-known are the joining systems used in the doors in the aeronautical sector, such as door closers. These systems have the disadvantage that they are often complex and cannot absorb structural loads. Door hooks are also known but have the disadvantage of being high in weight, mainly due to their complexity. In addition, this type of connection can only absorb axial loads.

### SUMMARY OF THE INVENTION

The invention responds, therefore, to the need for joining elements, more specifically to the joining of structural elements such as, for example, large panels. A purpose of the invention is that the joining system facilitates its assembly and disassembly and allows the absorption of misalignments between the elements to be joined. These misalignments may be due to dissimilar deformations of the components to be joined.

More specifically, the system object of the invention permits the joining between at least a first anterior element and a second posterior element, each of the components comprising a through hole.

The anterior element is understood to be the one at the front, and the posterior element is the one at the rear according to the direction of insertion of the joining system.

The system object of the invention may comprise:

A threaded bolt comprising a longitudinal axis is configured to pass through the through hole of the first and second elements. The threaded bolt comprises an anterior longitudinal zone and a posterior longitudinal zone.

A shank is configured to be located concentrically to the threaded bolt in at least the anterior longitudinal zone of the threaded bolt. The shank is configured to move together with said threaded bolt. The shank also comprises a curved outer face, i.e., its outer surface, comprising at least one tapered longitudinal section pointed towards the posterior longitudinal zone of the threaded bolt. Pointed indicates that its diameter decreases towards the posterior longitudinal zone of the threaded bolt.

A housing is configured to be attached to the second rear element. The housing comprises a tapered inner face, i.e., a tapered inner surface, for housing the shank in the mounted position of the joining system.

A clamping element is configured to thread the rear longitudinal area of the threaded bolt for the attachment of the joining system when mounted on at least the first element and the second element.

The threaded bolt, together with the clamping element, is responsible for the transfer of axial loads. The threaded bolt also creates the force required for assembly by rotating within the clamping element, such as a nut. The connecting element is the other element that holds the system fixed and transfers the axial loads. The connecting element reacts to the installation force exerted by the threaded bolt.

In turn, the shank transfers the shear load. During assembly of the joining system, the tapered section of the shank aligns the elements to be joined as it advances together with the threaded bolt.

The housing provides the necessary space for the tapered area of the shank to pass through the through holes of the elements to be joined and transfer the axial loads.

In addition, the conical area of the housing allows alignment by partly corresponding to the outer truncated cone shape of the shank.

The invention has one or more of the following advantages:
The correction of significant misalignments between through holes, e.g., bore-holes, of the elements to be joined.
The gradual transfer of load due to structural weight, for example, between the joined elements during assembly and disassembly. The gradual transfer is achieved by controlled tightening. As the tapered part is inserted into the through holes of the parts to be joined, the joint is loaded as the bolt and shank advance. Therefore, the alignment of the through holes occurs gradually as the joint is tightened/loosened due to the tapered part.
It is used for multiple assembly and disassembly cycles.
The reduction of the assembly time required for the pre-positioning of the elements to be joined. The invention saves time and tooling since it is otherwise necessary to precisely align the holes of the parts to be joined beforehand.
Reduced weight compared to, for example, door opening and closing elements such as hinges, latches, etc.
Easily accessible assembly and disassembly as it is not necessary to access both sides of the joint system since the invention allows access from the front side with no need to access the back side of the joint.
Ease of inspection/maintenance/repair.
Use in combination with other complementary solutions.

### BRIEF DESCRIPTION OF THE DRAWINGS

A set of drawings is provided to complete the description and provide a better understanding of the invention. These drawings form an integral part of the description and illustrate embodiments of the invention. The drawings comprise the following figures.

FIG. 1 shows a first example of the embodiment of a longitudinal section of a first element, a second element to be joined, and a joining system in the assembled position.

FIG. 2A shows a first step of an assembly sequence of a second example of an embodiment of a joining system according to the invention with a longitudinal section of a first element and a second element to be joined.

FIG. 2B shows a second step of the assembly sequence of the second example shown in FIG. 2A.

FIG. 2C shows a third step of the assembly sequence of the second example shown in FIG. 2A.

FIG. 2D shows a fourth step of the assembly sequence of the second example shown in FIG. 2A.

FIG. 2E shows a fifth step of the assembly sequence of the second example shown in FIG. 2A.

FIG. 3 shows a longitudinal section of a third embodiment example of a first element and a second element to be joined and of a joining system in the assembled position.

FIG. 4 shows a perspective view of the embodiment example corresponding to FIG. 3.

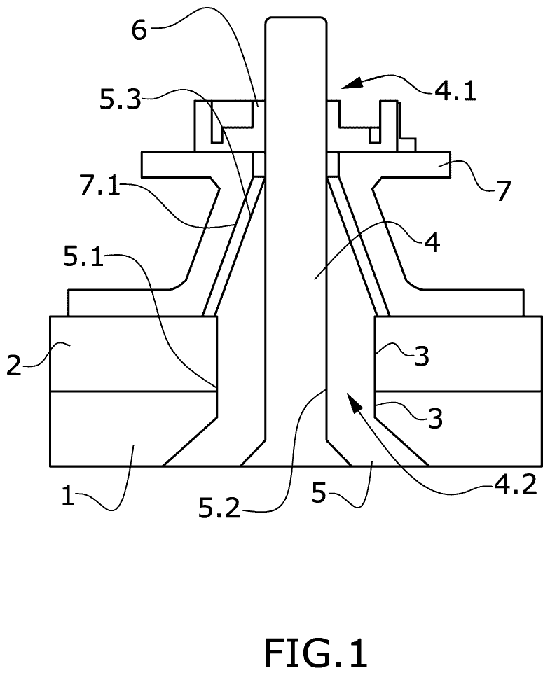

### DETAILED DESCRIPTION OF THE PREFERRED EMBODIMENTS

The figures show various examples of embodiments of the joining system of the invention.

The first element (1), located in an anterior position, and the second element (2) located in a posterior position are shown. Both elements (1, 2) comprise a through hole (3).

The first and second elements (1, 2) can be made of any material, e.g., metallic, composite material, CFRP, etc.

The depicted joining system comprises:

The threaded bolt (4) that passes through the through hole (3) of the first element (1) and of the second element (2). The threaded bolt (4) comprises a posterior longitudinal zone (4.1) and an anterior longitudinal zone (4.2).

The shank (5) is configured to be located concentrically to the threaded bolt (4) in at least the anterior longitudinal zone (4.2) of the threaded bolt (4). The shank (5) comprises an outer face (5.1) in which it includes at least one tapered longitudinal section (5.3) pointed towards the posterior longitudinal zone (4.1) of the threaded bolt (4).

The housing (7) is attached to the second posterior element (2). The housing (7) comprises a conical inner face (7.1) where the shank (5) is housed in its assembled position.

The clamping element (6) is threaded to the posterior longitudinal zone (4.1) of the threaded bolt (4) for fastening the joining system.

The housing (7) is attached to the second posterior element (2) by any means of attachment, e.g., riveted, adhesively bonded, etc.

In an embodiment example, the shank (5) is joined to the threaded bolt (4). This connection can be made, for example, by means of a pin or a ring. This connection facilitates the disassembly of the connection system.

In another embodiment, the shank (5) and the threaded bolt (4) form a single part. In this way, the number of parts in the joining system is reduced, which facilitates the disassembly of the system. In an embodiment example, this single part could consist of a solid shank (5), without an axial through bore-hole, that terminates at its rear in a threaded cylinder, i.e., the posterior longitudinal zone (4.1) of the threaded bolt (4) which is capable of engaging in the clamping element (6).

In an embodiment example, the clamping element (6) may be a nut.

In an embodiment example, the clamping element (6) comprises a spherical float. This allows for tilting of the shank (5) in the initial stages of assembly and permits assembly when the bore-hole of the first element (1) and the second element (2) are not aligned.

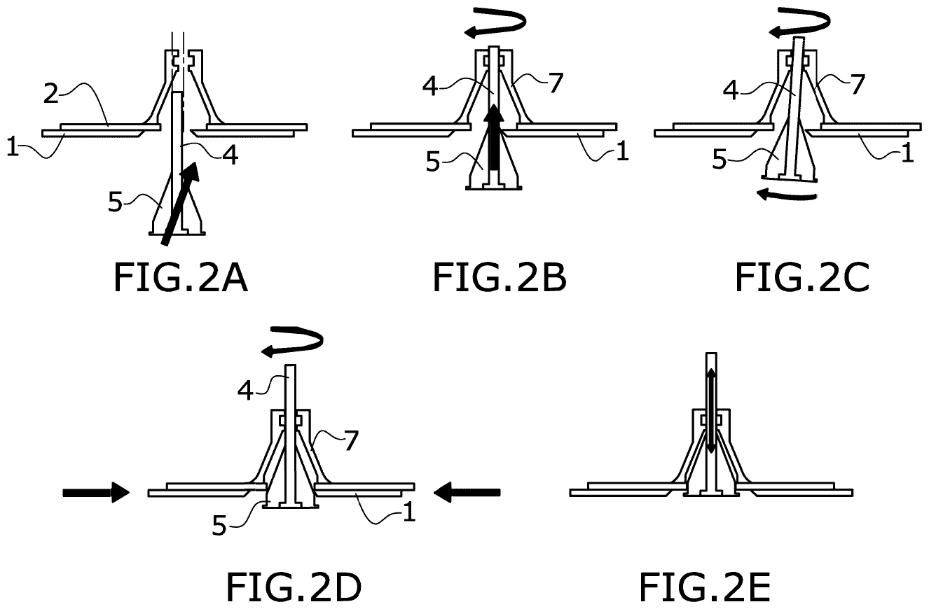

This movement is depicted in FIG. 2, where the third and fourth images of the assembly sequence allow tilting of the threaded bolt (4). The clamping element (6) leaves the threaded bolt (4) free to tilt while allowing the threaded bolt (4) to be screwed in.

Subsequently, the centering is obtained thanks to the male-female conical surfaces. The centering is, therefore, produced by the advancement of the male conical part over the through holes (3) of the elements (1, 2) to be joined. The female conical part serves as a housing, and its conical shape helps the threaded bolt (4) to advance toward the clamping element (6).

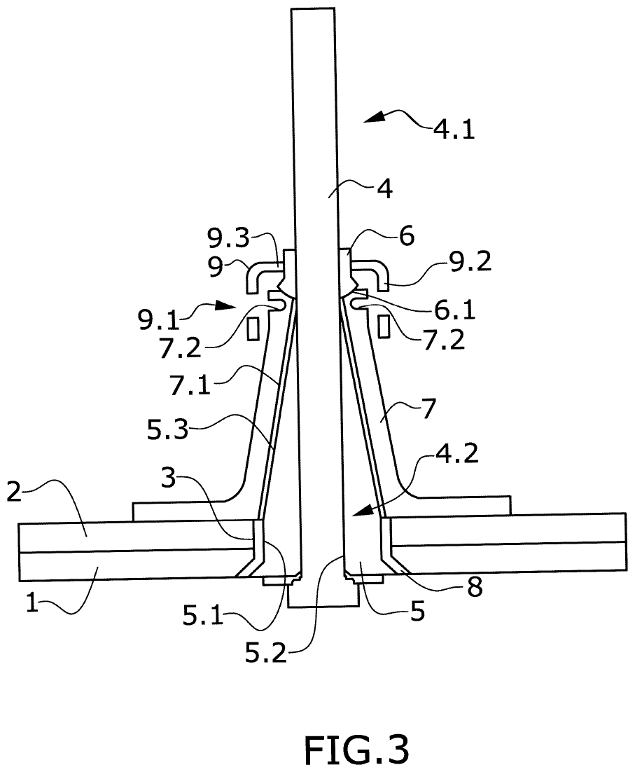

In addition, the clamping element (6) shown in FIG. 3 comprises a curved front part (6.1) that collaborates in this spherical mobility.

In the embodiment example of the figures, the joining system shown could comprise a bushing attached to the inner face (7.1) of the housing (7) to prevent wear of the said inner face (7.1). The said bushing is not shown in the figures.

In an embodiment example shown in the figures, the clamping element (6) is configured to be located downstream of the front end of the housing (7). The housing (7) and the clamping element (6) are configured in this manner so that the housing (7) is located longitudinally between the clamping element (6) and the second posterior element (2). It is, therefore, an element independent of the housing (7).

FIG. 2 shows a second example of the embodiment of the joining system of the invention and also the assembly sequence of the example of the embodiment.

The clamping element (6) forms a single part together with the housing (7). This embodiment example has the advantage that it avoids the possibility of the clamping element (6) falling into an inaccessible area, e.g., of an aircraft, thus improving the safety and ease of assembly of the joining system.

More specifically, in the embodiment example, the clamping element (6) is located at the rear end of the housing (7). More specifically, it corresponds to a nut embedded in the front end of the housing (7).

As discussed above, FIG. 2 describes the assembly sequence of the joining system.

In the first image, the first front element (1) and the second posterior element (2) are misaligned, i.e., their respective through holes (3) do not have the same longitudinal axis. In the sequence shown, it can be seen that the housing (7) is attached to the second element (2) at the rear. The threaded bolt (4), together with the shank (5), is inserted into the free part left by both through holes (3) from the front.

In the second image, the rear end of the threaded bolt (4) contacts the clamping element (6) and starts to thread into it (6).

In the embodiment example shown, the distance between the rear end of the threaded bolt (4) and the rear end of the shank (5) is greater than the length of the housing (7). In this way, the length of the threaded bolt (4) is such that it fits into the thread of the clamping element (6) when the rear end of the shank (5) is still outside of the through holes (3) of the elements to be joined (1, 2). This achieves that the threading controls the longitudinal displacement of the shank (5) and, thus, the axial force exerted by it on the elements to be joined (1, 2).

The third image represents the sliding and the deformation between the elements integrating the joining system object of the invention. As mentioned previously, the joining system allows an inclination between the threaded bolt (4) and the housing (7).

The fourth image shows how the shank (5) pushes the second posterior element (2), whose through hole (3) is aligned with the through hole (3) of the first element (1) above.

The last picture shows the final configuration of the connection system in its assembled position.

In both embodiments, the conical inner face (7.1) of the housing (7) has a complementary shape to the outer face (5.1) of the shank (5) so that both elements are perfectly adjusted once the joining system is assembled.

In the embodiments shown, the shank (5) and the threaded bolt (4) are flush at the rear.

During alignment, high pressure can be applied to the edges of the through holes (3) of the elements (1, 2) to be joined. To prevent material wear, the joining system may include bushings (8), for example, of hard metal located in said through holes (3), as shown, for example, in FIG. 3.

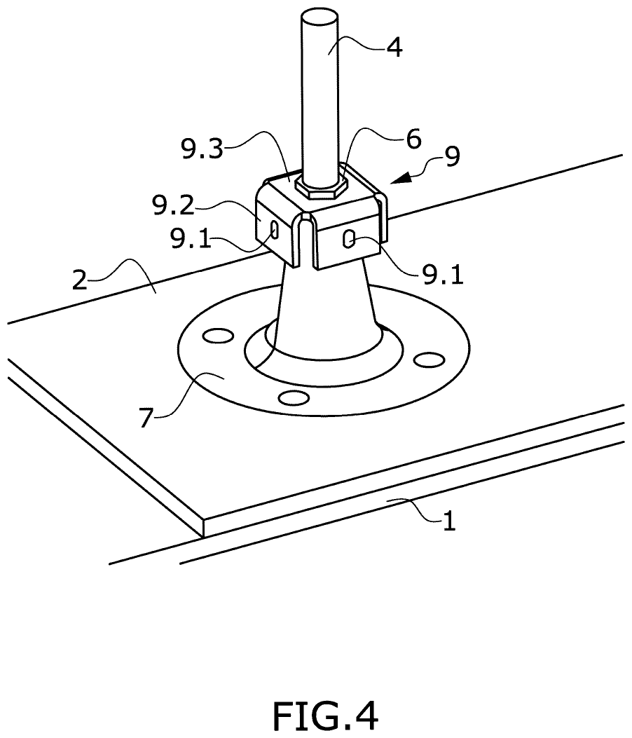

FIGS. 3 and 4 depict an example embodiment in which the joining system comprises a retaining sleeve (9) in connection with the clamping element (6), for example, with a nut. The retaining sleeve (9) comprises means for:
preventing rotation of the said clamping element (6) about the longitudinal axis of the threaded bolt (4), and.
limiting the displacement along the longitudinal axis of the threaded bolt (4) of said clamping element (6).

Thus, the retaining sleeve (9) limits the clamping element (6) both in its rotation around the threaded bolt (4) and in the longitudinal displacement with respect to the said threaded bolt (4). To a certain extent, the retaining sleeve (9) acts as a housing for the clamping element (6).

This arrangement has advantages, for example, when disassembling the joining system, which would be carried out from the front side of the joining system. During disassembly, the threaded bolt (4) moves longitudinally toward the front of the joining system and, at a specified point, loses contact with the clamping element (6). The retaining sleeve (9) acts as a housing for the clamping element (6), preventing the clamping element (6) from falling or displacing into an inaccessible part of, for example, an aircraft.

According to the example embodiment shown in the figures, the retaining sleeve (9) comprises a first surface (9.3) intended to be located in a mounting position perpendicular to the longitudinal axis of the threaded bolt (4). The first surface (9.3) comprises a hole to house the clamping element (6). In an exemplary embodiment, this first hole is complementary in shape to the clamping element (6). In this way, the retaining sleeve (9) prevents the rotation of the clamping element (6) around the longitudinal axis of the threaded bolt (4).

In the example embodiment shown, the retaining sleeve (9) also comprises at least a second surface (9.2) intended to be located in a mounting position parallel to the longitudinal axis of the threaded bolt (4). This second surface (9.2) partially covers longitudinally the clamping element (6) and the rear part of the housing (7). The second surface (9.2) is connected to the first surface (9.3).

In the embodiment example shown, the retaining sleeve (9) comprises four second surfaces (9.2), as seen in FIG. 4. It could alternatively comprise a single continuous second surface (9.2) that would surround the threaded bolt (4).

The second surface (9.2) comprises at least a second hole (9.1) for the insertion of a through element for joining the retainer bushing (9) with the housing (7). In this second hole (9.1), a screw can be inserted, the tip of which would be located in the housing (7). In this way, the retaining sleeve (9) remains attached to the housing (7), preventing the longitudinal displacement and rotation between the two elements.

In the embodiment example shown in the figures, the housing (7) also has a hole (7.2) opposite the second orifices (9.1) of the retaining sleeve (9) for the insertion of the screw mentioned above.

In the example shown in FIGS. 3 and 4, there is a gap (not shown) between the clamping element (6) and the retaining sleeve (9). Said clearance allows for the maintenance of the possibility of a spherical rotation of the clamping element (6), i.e., around the two axes orthogonal to the longitudinal axis. As commented previously, this allows that in the initial phases of assembly, it is possible to produce the inclination of the threaded bolt (4) and of the shank (5), allowing the assembly when the holes of the first element (1) and the second element (2) are not aligned. The spherical rotation of the clamping element (6) allows the connection of the threaded bolt (4) and the clamping element (6) when the threaded bolt (4) is still inclined.

Finally, in the embodiment example shown in FIGS. 3 and 4, the clamping element (6) comprises an anterior zone of greater radial dimension than the rear zone located in correspondence with the hole of the first surface (9.3). Specifically, the curved front part (6.1) has a larger dimension in the transverse direction than the said hole. This helps to ensure that the clamping element (6) is retained in the retaining sleeve (9) once it is separated from the threaded bolt (4). It also provides a contact surface between the clamping element (6) and the housing (7) adapted to the case in which the threaded bolt (4) and the clamping element (6) are inclined.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claimed is:

1. A joining system for joining at least a first anterior element and a second posterior element, each of the elements comprising a through hole, the joining system comprising:
a threaded bolt configured to pass through the through hole of the first anterior element and the second posterior element and comprising a longitudinal axis, a posterior longitudinal zone, and an anterior longitudinal zone,
a shank configured to be located concentrically to the threaded bolt in at least the anterior longitudinal zone of the threaded bolt and configured to move together with said threaded bolt, the shank comprising an outer face comprising at least a tapered longitudinal section pointing towards the posterior longitudinal zone of the threaded bolt,
a housing configured to be attached to the second posterior element and comprising a conical inner face for housing the shank in an assembled position of the joining system, and
a clamping element configured to thread the posterior longitudinal zone of the threaded bolt to fasten the joining system when the joining system is mounted on at least the first anterior element and the second posterior element.

2. The joining system according to claim 1, wherein the shank is attached to the threaded bolt.

3. The joining system according to claim 1, wherein the shank and the threaded bolt form a single piece.

4. The joining system according to claim 1, wherein the conical inner face of the housing comprises a shape complementary to the outer face of the shank.

5. The joining system according to claim 1, wherein the clamping element and the housing form a single piece.

6. The joining system according to claim 5, wherein the clamping element is located at a rear end of the housing.

7. The joining system according to claim 1, wherein the housing and the clamping element are configured so that the housing is located longitudinally between the clamping element and the second posterior element.

8. The joining system according to claim 1, wherein the clamping element is a nut.

9. The joining system according to claim 8, wherein the clamping element and the housing form a single piece,
wherein the clamping element is located at a rear end of the housing, and
wherein the nut is embedded in the housing.

10. The joining system according to claim 1, wherein the clamping element comprises a spherical float.

11. The joining system according to claim 10, wherein the clamping element comprises a curved front part.

12. The joining system according to claim 1, wherein a distance between a rear end of the threaded bolt and a rear end of the shank is greater than a length of the housing.

13. The joining system according to claim 1, further comprising:
a retaining sleeve in connection with the clamping element, the retaining sleeve comprising means to:
prevent a rotation of the clamping element about the longitudinal axis of the threaded bolt, and
limit a displacement of the clamping element along the longitudinal axis of the threaded bolt.

14. The joining system according to claim 13, the retaining sleeve comprises a first surface configured to be located, in a mounting position, perpendicular to the longitudinal axis of the threaded bolt and comprising a first hole for housing the clamping element.

15. The joining system according to claim 14, wherein the retaining sleeve comprises at least a second surface configured to be located, in the mounting position, parallel to the longitudinal axis of the threaded bolt so as to longitudinally partially cover the clamping element and a rear part of the housing, the second surface comprising at least a second hole for insertion of a through element for connecting the retaining sleeve to the housing.
